(19) United States
(12) Patent Application Publication
(10) Pub. No.: US 2006/0175368 A1
(43) Pub. Date: Aug. 10, 2006

(54) Modular roof cargo container movable to a rear loading position

(75) Inventors: Robert E. Fallis III, Rochester, MI (US); Michael T. Willard, Harrison Twsp., MI (US)

Correspondence Address: BROOKS KUSHMAN P.C., 1000 TOWN CENTER, TWENTY-SECOND FLOOR, SOUTHFIELD, MI, 48075, US

(73) Assignee: CTS Fahrzeug Dachysteme GmbH, Rochester Hills, MI (US)

(21) Appl. No.: 11/346,683

(22) Filed: Feb. 3, 2006

Related U.S. Application Data
(60) Provisional application No. 60/650,228, filed on Feb. 4, 2005.

(51) Int. Cl. B60R 9/00

(52) U.S. Cl. 224/310; 224/328

(57) ABSTRACT

A cargo container for a vehicle including an enclosure or movable supporting member that is connected by a linkage to the vehicle. The linkage may be used to shift the enclosure between a transport position above the roof and a loading position behind the vehicle. The linkage has a right side and a left side. Each side has a forward member that translates the front end of the enclosure in the fore-and-aft direction. A rearward pivoting member lifts portions of the enclosure behind the forward member upwardly to clear a rear corner of the vehicle as the enclosure is moved between the transport position and the loading position.

### CROSS-REFERENCE TO RELATED APPLICATIONS

This application claims the benefit of U.S. provisional application Ser. No. 60/650,228 filed Feb. 4, 2005.

### BACKGROUND OF THE INVENTION

1. Field of the Invention

The present invention relates to a cargo storage container that is carried above a vehicle roof and is moveable to a position rearward of the tailgate of the vehicle for loading and unloading.

2. Background Art

Roof cargo storage containers are used to provide additional storage capacity for vehicles. Roof racks may also be used to secure cargo to a vehicle roof. One problem associated with roof racks is that objects secured to a roof rack are not protected from precipitation or road spray unless the objects are securely wrapped in a waterproof covering.

Molded plastic cargo carriers have been developed to provide a way to carry cargo on the roof of a vehicle in a sealed container. A problem with most roof mounted cargo carriers is that it is difficult to load and unload a container that is mounted on the top of a van or sport utility vehicle because of the height of the roof of such vehicles. If the cargo carrier is loaded before being mounted on the roof of a vehicle, the increased weight can make it difficult to lift the cargo carrier up to the roof.

Another problem with roof top cargo carriers is that the top of such carriers must be secured to the container to form a seal with the container. The top also must be secured so that it cannot open when the carrier is being transported by a vehicle. Cargo in such carriers is also subject to potential theft by unauthorized persons breaking into the carrier or by removing the entire carrier.

To address the loading problem, several solutions are proposed in the prior art in which a roof mounted cargo carrier is moveable to a position rearward of the tailgate of the vehicle. For example, U.S. Pat. No. 4,291,823 discloses a track mounted pull down luggage carrier for a vehicle in which a cargo carrier is provided with wheels that follow track that are attached to the roof of the vehicle. This patent also discloses a concept of providing springs that are used to lift and hold the carrier in its rooftop position.

Another approach is disclosed in U.S. Pat. No. 5,423,650 that discloses a retractable cargo rack assembly that may be tipped from a rooftop position to a rear loading position. The cargo rack assembly has platforms that may be pivoted to a loading position at the rear of the vehicle.

Another proposed solution is disclosed in U.S. Pat. No. 6,427,888 that discloses a vehicle rooftop luggage holder that may be used to carry a bicycle or other object that is loaded onto the holder at the rear of the vehicle and then shifted to a rooftop position.

The above prior art approaches are generally relatively complex structures that are difficult to install and use. Further, the structures generally do not provide a sealed cargo container that is easy to open and conveniently shifted between a rear loading position and a rooftop position.

The above problems are addressed by applicant's invention that is described below.

### SUMMARY OF THE INVENTION

According to one aspect of the present invention, a carrier for a vehicle is provided that is carried above a roof portion of the vehicle and is movable to a loading position behind the vehicle. The carrier comprises an enclosure having a body portion and a cover portion that is used to selectively close an opening in the body portion. A linkage is secured between the vehicle and the enclosure. The linkage has a transport position in which the enclosure is carried above the roof and a loading position in which the linkage holds the enclosure behind the vehicle. The linkage has a right side and a left side that each have a forward member that translates a forward portion of the enclosure parallel to the roof portion and a rearward member that lifts the portions of the enclosure behind the forward member upwardly to clear a rear corner of the vehicle as the enclosure is moved between the transport position and the loading position.

According to other aspects of the invention as they relate to the carrier, each side of the linkage may have a stationary roof rack that defines a slot. The forward member may have a movable bracket that has a follower that is received in the slot in the roof rail. The rearward member may have a link that connects the body portion of the enclosure to the roof rack rail. Each side of the linkage may further comprise a lid link connecting the link and the cover portion that lifts the cover portion off of the body portion as the enclosure is moved to the loading position and that lowers the cover portion onto the body portion as the enclosure is moved to the transport position. The bracket on opposite lateral sides of the enclosure may move from a forward position on the roof rack rail wherein the enclosure is in the transport position to a rearward position on the roof rack rail when the enclosure is in the loading position. The link may be pivotally connected to a pivot connection adjacent a rear portion of the roof rack rail so that the link pivots rearwardly to initially lift a rearward portion of the enclosure as the enclosure is moved from the transport position. The link comprising the rearward member continues to pivot rearwardly moving the enclosure to the loading position.

According to other aspects of the invention as they relate to the carrier, the cover may be held by the linkage in a spaced relationship relative to the opening when the enclosure is in the loading position. The cover may also be held by the linkage over the opening in the transport position to close the opening.

According to other aspects of the invention, a mechanical drive system may be secured to the carrier and the vehicle to move the carrier fore-and-aft relative to the vehicle. The mechanical drive system may comprise a cable that is at least partially routed through a roof rack rail and that is driven by a motor that extends and retracts the cable.

According to another aspect of the present invention, a cargo container for a vehicle is provided that comprises the housing and a linkage that secures the housing to the vehicle. The linkage has a right side and a left side that are utilized to move the housing between a load carrying position in which the housing is disposed above the vehicle and a loading position in which the housing is disposed outboard of a back side of the vehicle. Each side of the linkage has a movable forward connector that secures a front portion of the housing to a longitudinally extending rail that is connected to a roof of the vehicle for movement along the rail. The forward connector is movable from a forward portion of the rail in a load carrying position to a rearward portion of the rail in the loading position. Each side of the linkage also has a pivoting link secured to a rear portion of the rail and a side of the housing. The pivoting link extends forward of the rear portion of the rail to support the housing in the load carrying position. The pivoting link extends upward from the rear portion of the rail as the housing is moved between the load carrying position and the loading position. The pivoting link extends rearward and downward from the rear position of the rail in the loading position.

According to other aspects of the invention as they relate to the cargo container embodiment, the housing may have a lid that is selectively positioned to close an opening in a top portion of the housing. The cargo container may further comprise a lid link secured to the pivoting link and lid wherein the lid is connected by a hinge to the housing on one end. The lid link may be rotated by the pivoting link to close the lid when the housing is in the load carrying position and to open the lid when the housing is in the loading position. Alternatively, the lid may be selectively positioned by manually manipulating the lid relative to the housing. The pivoting link is preferably secured to an intermediate location on the side of the housing. The lid and lid link may be secured to an intermediate location on the pivoting link between the point at which the pivoting link is secured to the housing and the rear portion of the rail. Each of the longitudinally extending rails may define a track that receives a forward connector and guides movement of the forward connector along the rail.

According to another aspect of the present invention, a car top carrier for a vehicle having a roof and a tailgate disposed behind and below the roof is disclosed. The car top carrier comprises a roof rack that is fixedly secured to the vehicle. A movable supporting member is secured to the roof rack that is movable between a transporting position above the roof rack and a loading position adjacent to the tailgate. A right front connector and a rear front connector are secured to the supporting member at a forward location and are translatable relative to the roof rack. The right rear pivoting link and a left rear pivoting link are secured to the supporting member at a location rearward of the front connector and are connected to the roof rack adjacent to a top corner of the vehicle defined by a rear edge of the roof and a top edge of the tailgate.

According to other aspects of the invention, the right and left pivoting links may rotate about the point at which the links are connected to the roof rack to lift a rear portion of the supporting member vertically over the top corner while the right and left front connectors move fore-and-aft along the roof rack.

### BRIEF DESCRIPTION OF THE DRAWINGS

FIG. 1 is a rear perspective view of the modular roof cargo container of the present invention shown secured to the roof a vehicle that is shown in phantom lines;

FIG. 2 is rear perspective view of the modular roof cargo container in its open rear loading position;

FIG. 3 is a side elevation view of the modular roof cargo container in its rooftop position;

FIGS. 4-7 are a series of a side elevation views of the modular roof cargo container shown as it is being moved sequentially toward the rear loading position and also shows how the cover or lid portion is opened to provide access to the interior of the covered container;

FIG. 8 is a side elevation view showing the cargo container disposed in a rear loading position with the cover or lid in its open position;

FIG. 9 is a partially exploded perspective view of a roof cargo container illustrating a power operated cable embodiment; and

FIG. 10 is a fragmentary exploded perspective view of a link pivot connector.

### DETAILED DESCRIPTION OF THE PREFERRED EMBODIMENT(S)

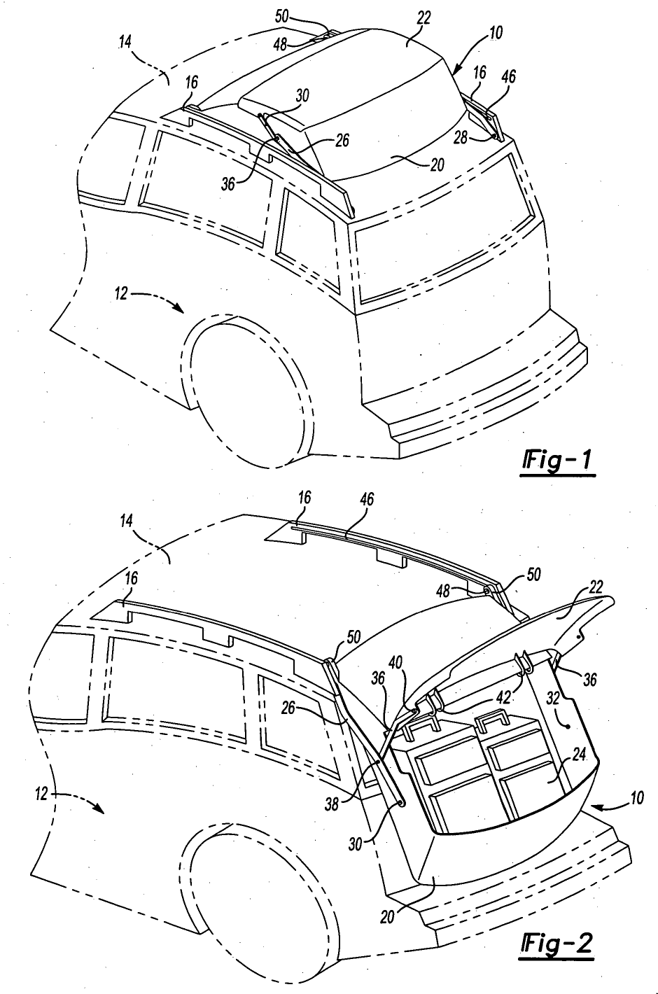

Referring to FIGS. 1 and 2, a cargo container 10 is shown in conjunction with a vehicle 12. In FIG. 1, the cargo container 10 is secured in place on top of the roof 14 of the vehicle 12. The cargo container 10 is stowed on the roof 14 between a pair of roof rack rails 16. The cargo container 10 is permanently attached to the roof rack rails that discourages theft of the cargo container 10. In FIG. 2, the cargo container 10 is shown moved to the rear of the vehicle 12. The cargo container 10 includes a body shell 20 and a lid 22. Suitcases 24 or other cargo items may be placed in the cargo container 10 when cargo container 10 is in its rear loading position and the lid 22 is opened.

A primary link 26 connects the cargo container 10 to a pin 28 that is located near the rear of the roof rack rail 16. The opposite end of the primary link 26 is connected by a box pin 30. A hole 32 is provided in the body shell 20 for receiving the box pin 30.

A lid link 36 extends between the primary link 26 and the lid 22. One end of the lid link is connected by a pivot pin 38 to the primary link 26. The opposite end of the lid link 36 is connected by a lid pivot pin 40 to the lid 22. The lid 22 is connected to the body shell 20 by hinges 42. The lid link 36 holds the lid 22 closed when it is on top of the vehicle discouraging unauthorized access to the cargo in the cargo container 10.

It should be understood that in the illustrated embodiment, an automatic lid opening and closing mechanism is disclosed that opens the lid 22 as the cargo container 10 is moved toward its loading position, as shown in FIG. 2. As an alternative, a manually opened lid 22 may be provided that would not require the lid link 36. In the manual embodiment, handles would be provided to open the lid 22.

Slots 46 are formed in the roof rack rail 16. Guide pins 48 are provided on front brackets 50 at the front end of the cargo container 10. The guide pins 48 are slidably received in the slots 46 to guide the movement of the front end of the cargo container 10 as the guide pins 48 are moved from the front of the roof rack rail 16 to the rear of the roof rack rail 16.

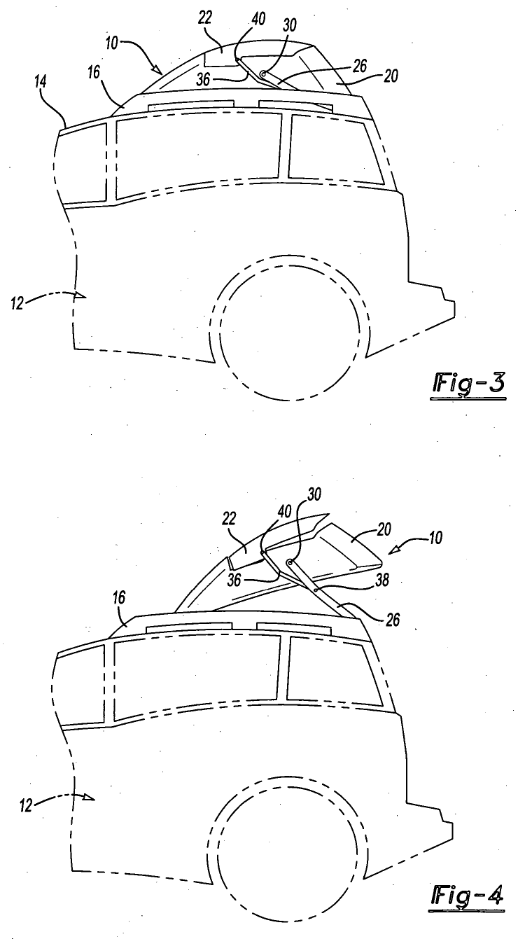

Referring to FIGS. 3-8, the cargo container 10 is shown in a series of views as it is moved from the roof mounted position shown in FIG. 3 to the rear loading position shown in FIG. 8. In FIG. 3, the cargo container 10 is shown on the vehicle 12. The cargo container 10 is disposed on the roof 14 of vehicle 12. In this position, the lid 22 is in its closed position on the body shell 20. Primary link 26 holds the lid 22 in its closed position with the lid link 36.

Referring to FIG. 4, the cargo container 10 is shifted in a rearward direction and is raised by the primary link 26 to pivot about the upper rear corner of the vehicle 12. The lid link 36 is moved slightly by the primary link 26 that pivots about the pivot pin 38. The lid 22 is shown slightly raised above the body shell 20.

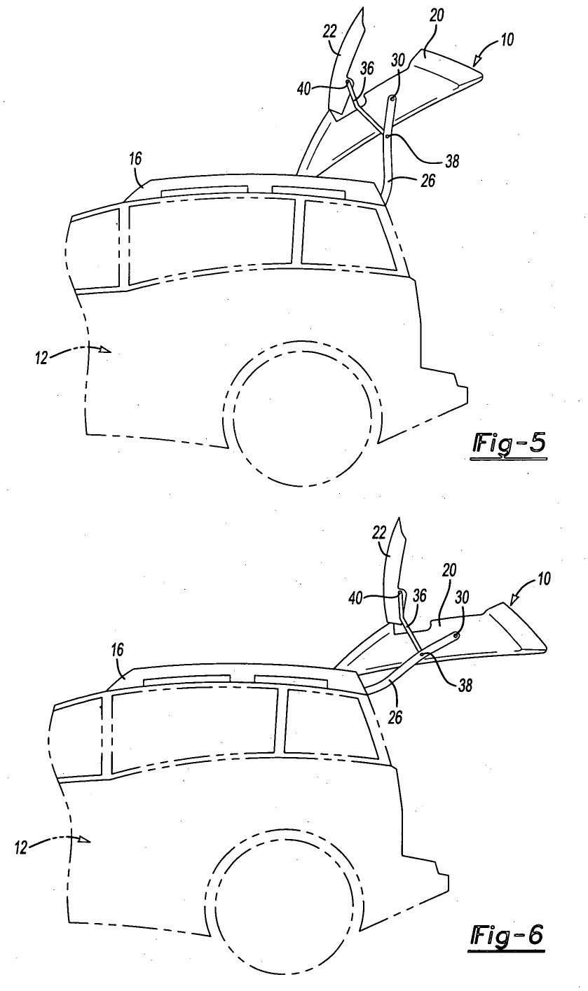

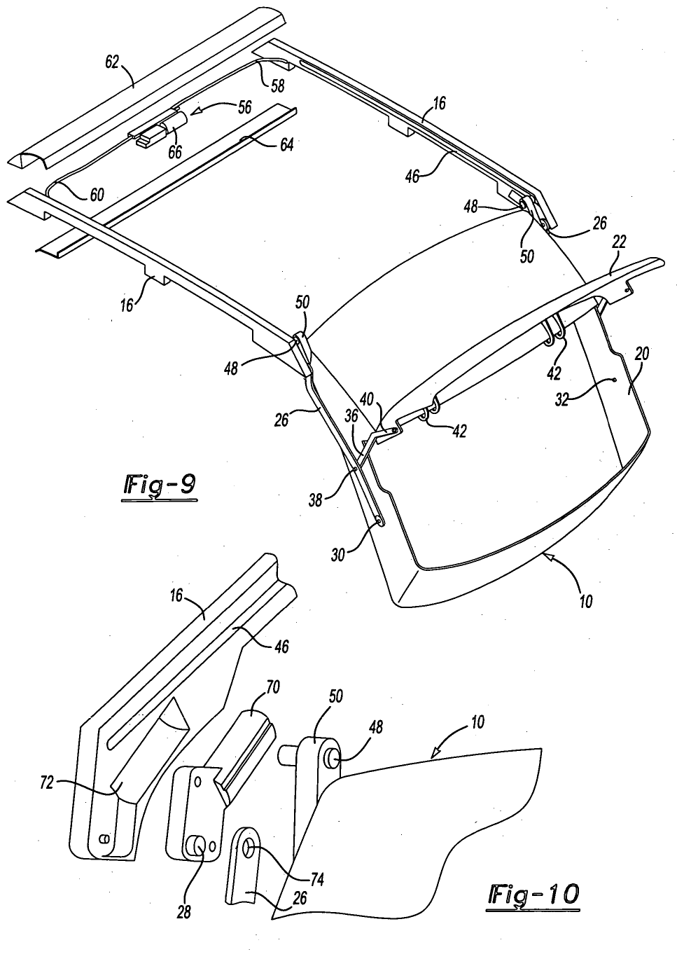

FIG. 5 illustrates the primary link 26 in a nearly vertical orientation lifting the cargo container 10 and pivoting it about the front edge of the cargo container. The cargo container 10 is retained between the roof rack rails 16, as will be more specifically described below with reference to FIGS. 9 and 10. The lid link 36 is rotated about the pivot pin 38 to further separate the lid 22 from the body shell 20.

Referring to FIG. 6, the cargo container 10 is shown shifted almost completely to the rear end of the roof rack rail 16. The primary link 26 extends rearwardly and slightly upwardly. Lid link 36 has been rotated about pivot pin 38 to a position wherein the lid 22 is nearly vertical.

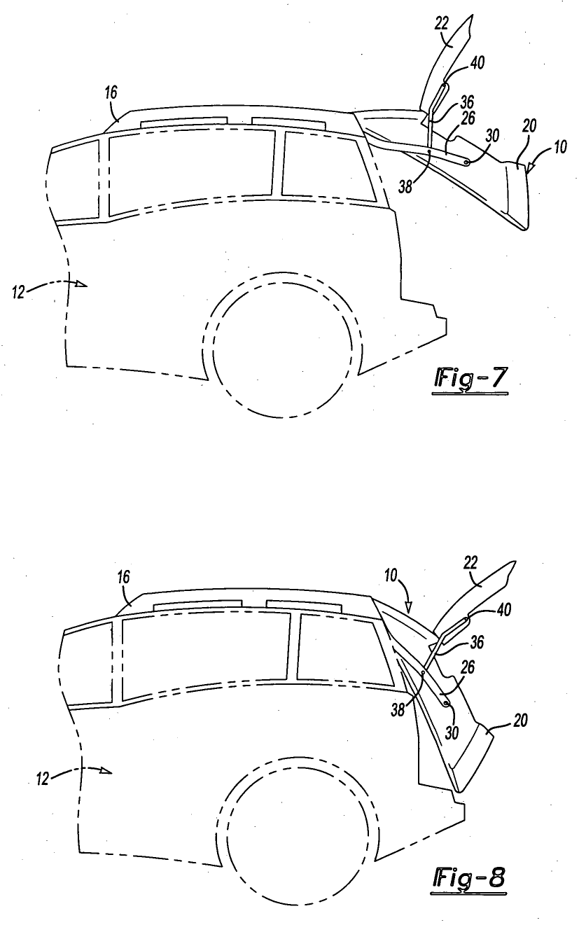

Referring to FIG. 7, the cargo container 10 is shown as it is lowered against the rear portion of the vehicle 12 by the primary links 26. The lid 22 is fully opened relative to the body shell 20 and is held open by the lid link 36.

Referring to FIG. 8, the cargo container 10 is shown in its position at the rear of the vehicle 12 and is ready to be loaded with suitcases, or the like. The primary link 26 is rotated to a rearwardly and downwardly oriented position. The body shell 20 is located adjacent to the rear portion of the vehicle 12. The lid link 36 holds the lid 22 in its fully open position thereby allowing easy access to the storage space within the body shell 20.

Referring to FIGS. 9 and 10, the cargo container 10 is shown in conjunction with the roof rack rail 16. The body shell 20 is in its loading position with the lid 22 being held open by the lid link 36. A cable drive system, generally indicated by reference numeral 56, is shown in conjunction with the roof rack rail 16 and cargo container 10. The cable drive system 56 is used to raise and lower the cargo container 10 in a controlled manner. Right and left cables 58 and 60 are routed through the respective roof rack rails 16 and connected to the cargo container 10. The right and left cables 58 and 60 may be secured to the front brackets 50 to slide the guide pins 48 in the slots 46 of the roof rack rails 16. The cable drive system 56 is substantially enclosed by a cover 62 and base 64 that extend between the front ends of the roof rack rails 16. A combined motor and gear reducer 66 is operatively connected to the right and left cables 58 and 60 to move the cables 58 and 60 and the cargo container 10 in a controlled manner between its roof top mounted position and the rear loading position.

The cable drive system 56 could be replaced with a hydraulic cylinder drive mechanism or a worm screw mechanism. A hydraulic cylinder or worm screw could be provided in each of the roof rack rails 16 to drive the cargo container between the roof top and rear loading positions.

While the embodiments shown in FIG. 9 include the lid link 36 that holds the lid 22 open, it should be understood that, as an alternative, the lid link 36 could be eliminated and the lid 22 could be opened manually.

Referring to FIG. 10, the cargo container 10 and roof rack rails 16 are partially shown to illustrate the connection of the cargo container through the front brackets 50 and guide pin 48. Guide pin 48 is received in the slot 46 in the roof rails 16. The primary link 26 is secured to the roof rack rails 16 through a reinforcement plate 70 that is mounted in a cavity 72 formed in the rear portion of the roof rack rails 16. The primary link 26 is provided with a hole 74 in one end for receiving a pin 28 that may be formed on the reinforcement plate 70. Each of the primary links 26 pivot on the pins 28 as each of the guide pins 48 moves reciprocally within one of the slots 46.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A carrier for a vehicle that is carried above a roof portion of the vehicle and is moveable to a loading position behind the vehicle, the carrier comprising:
an enclosure having a body portion and a cover portion, the body portion having an opening that is selectively closed by the cover portion; and
a linkage secured between the vehicle and the enclosure, the linkage having a transport position in which the enclosure is carried above the roof and the loading position in which the linkage holds the enclosure behind the vehicle, the linkage having a right side and a left side, wherein each side of the linkage has a forward member that translates a forward portion of the enclosure parallel to the roof portion and a rearward member that lifts the portions of the enclosure behind the forward member upwardly to clear a rear corner of the vehicle as the enclosure is moved between the transport position and the loading position.

2. The carrier of claim 1 wherein each side of the linkage has a stationary roof rack rail that defines a slot, the forward member has a moveable bracket that has a follower that is received in the slot in the roof rack rail, and the rearward member has a link that connects the body portion of the enclosure to the roof rack rail.

3. The carrier of claim 2 wherein each side of the linkage further comprises a lid link connecting the link and the cover portion that lifts the cover portion off of the body portion as the enclosure is moved to the loading position and that lowers the cover portion onto the body portion as the enclosure is moved to the transport position.

4. The carrier of claim 2 wherein the bracket on opposite lateral sides of the enclosure moves from a forward position on the roof rack rail when the enclosure is in the transport position to a rearward position on the roof rack rail when the enclosure is in the loading position.

5. The carrier of claim 2 wherein the link is pivotally connected to a pivot connection adjacent a rear portion of the roof rack rail, wherein the link pivots rearwardly to initially lift a rearward portion of the enclosure as the enclosure is moved from the transport position, the link continues to pivot rearwardly moving the enclosure to the loading position.

6. The carrier of claim 1 wherein the cover is held by the linkage in a spaced relationship relative to the opening when the enclosure is in the loading position.

7. The carrier of claim 1 wherein the cover is held by the linkage over the opening in the transport position to close the opening.

8. The carrier of claim 1 further comprising a mechanical drive system secured to the enclosure and the vehicle that moves the enclosure fore-and-aft relative to the vehicle.

9. The carrier of claim 9 wherein the mechanical drive system is a cable that is at least partially routed through a roof rack rail and that is driven by a motor that extends and retracts the cable.

10. A cargo container for a vehicle comprising:
a housing; and
a linkage securing the housing to the vehicle, the linkage having a right side and a left side that moves the housing between a load carrying position in which the housing is disposed above the vehicle and a loading position in which the housing is disposed outboard of a back side of the vehicle, wherein each side of the linkage has a moveable forward connector that secures a front portion of the housing to a longitudinally extending rail connected to a roof of the vehicle to be moveable along the rail, the forward connector being moveable from a forward portion of the rail in the load carrying position to a rearward portion of the rail in the loading position, each side of the linkage having a pivoting link secured to a rear portion of the rail and a side of the housing, the pivoting link extending forward of the rear portion of the rail to support the housing in the load carrying position, the pivoting link extending upward from the rear portion of the rail as the housing is moved between the load carrying position and the loading position, and the pivoting link extending rearward and downward from the rear portion of the rail in the loading position.

11. The cargo container of claim 10 wherein the housing has a lid that is selectively positioned to close an opening in a top portion of the housing.

12. The cargo container of claim 11 further comprising a lid link secured to the pivoting link and the lid, the lid being connected by a hinge to the housing on one end, and the pivoting link being rotated by the lid link to close the lid when the housing is in the load carrying position and to open the lid when the housing is in the loading position.

13. The cargo container of claim 11 wherein the lid is selectively positioned by manually manipulating the lid relative to the housing.

14. The cargo container of claim 10 wherein the pivoting link is secured to an intermediate location on the side of the housing.

15. The cargo container of claim 10 further comprising a lid and a lid link that is secured to an intermediate location on the pivoting link between the point at which the pivoting link is secured to the housing and the rear portion of the rail.

16. The cargo container of claim 10 wherein each of the longitudinally extending rails define a track that receives the forward connector and guides movement of the forward connector along the rail.

17. A car top carrier for a vehicle having a roof and a tailgate disposed behind and below the roof, the car top carrier comprising:
a roof rack fixedly secured to the vehicle;
a moveable supporting member secured to the roof rack that is moveable between a transporting position above the roof rack and a loading position adjacent the tailgate;
a right front connector and a rear front connector that are secured to the supporting member at a forward location and are translatable relative to the roof rack;
a right rear pivoting link and a left rear pivoting link that are secured to the supporting member at a location rearward of the front connectors and are connected to the roof rack adjacent a top corner of the vehicle defined by a rear edge of the roof and a top edge of the tailgate.

18. The car top carrier of claim 17 wherein the right and left pivoting links rotate about the point at which the links are connected to the roof rack to lift a rear portion of the supporting member vertically over the top corner while the right and left front connectors move fore-and-aft along the roof rack.
